(19) United States
(12) Patent Application Publication
(10) Pub. No.: US 2016/0342246 A1
(43) Pub. Date: Nov. 24, 2016

(54) ELECTROMAGNETIC TOUCH SUBSTRATES AND DISPLAY DEVICES

(71) Applicant: SHENZHEN CHINA STAR OPTOELECTRONICS TECHNOLOGY CO., LTD., Shenzhen City, Guangdong (CN)

(72) Inventor: Xiangyang XU, Shenzhen, Guangdong (CN)

(73) Assignee: Shenzhen China Star Optoelectronics Technology Co., Ltd., Shenzhen, Guangdong (CN)

(21) Appl. No.: 14/426,162

(22) PCT Filed: Dec. 29, 2014
(86) PCT No.: PCT/CN2014/095387

§ 371 Date: Mar. 5, 2015

(30) Foreign Application Priority Data
Dec. 12, 2014 (CN) 201410770406.8

(51) Int. Cl. G06F 3/046; G06F 3/041

(52) U.S. Cl. CPC G06F 3/046; G06F 3/0412

(57) ABSTRACT

An electromagnetic touch substrate is disclosed. The electromagnetic touch substrate includes a substrate, a first conductive layer, an insulation layer, and a second conductive layer. The first conductive layer includes a plurality of first electromagnetic coils extending along a first direction, and the first electromagnetic coils form a loop. The second conductive layer includes a plurality of second electromagnetic coils extending along a second direction, and the second electromagnetic coils form a loop. The second direction is vertical to the first direction. The first electromagnetic coils, the insulation layer, and the second electromagnetic coils are arranged on the same side of the substrate. The insulation layer is configured for separating the first conductive layer and the second conductive layer. In this way, the display panel is embedded with the touch panel so as to provide a thinner electromagnetic touch substrate.

### BACKGROUND OF THE INVENTION

1. Field of the Invention

The present disclosure relates to tablet display technology, and more particularly to an electromagnetic touch substrates and display devices.

2. Discussion of the Related Art

With the development of display technology, touch-related technology has been adopted by a variety of electronic devices for daily life and jobs. Users may input information via hands or other objects by contacting touch panels such that users may input data without input devices, such as keyboards.

Generally, touch panels include resistive, capacitive, inductive, and optical touch panels. With respect to the inductive touch panels, a distance between the touch panel configured with field coils or induction coils may be changed by controlling the coils of a specific magnetic pen, i.e., changing the magnetic field of the electromagnetic coils of the touch panel. As such, a weak current may be generated and thus a touch detection unit may obtain the location of touch points via calculations.

Conventional electromagnetic touch panels usually adopts on-cell inductive touch boards, whose carrier may be flexible circuit board. The on-cell inductive touch board has been assembled with a display panel to form the inductive touch panel such that a thickness of the inductive touch panel may increase. In addition, the flexible circuit board of the inductive touch panels increases the cost.

### SUMMARY

The present disclosure relates to an embedded electromagnetic touch panel and the display device.

In one aspect, an electromagnetic touch substrate includes: a substrate, a first conductive layer, an insulation layer, and a second conductive layer, the first conductive layer includes a plurality of first electromagnetic coils extending along a first direction, the first electromagnetic coils form a loop, the second conductive layer includes a plurality of second electromagnetic coils extending along a second direction, the second electromagnetic coils form a loop, the second direction being vertical to the first direction, the first electromagnetic coils, the insulation layer, and the second electromagnetic coils are arranged on the same side on the substrate in sequence, and the insulation layer being configured for separating the first electromagnetic coils and the second electromagnetic coils; at least one black matrix arranged on the substrate, the first electromagnetic coils and the second electromagnetic coils are arranged above the black matrix; the first electromagnetic coils includes two first sensing electrodes arranged along the first direction, the first sensing electrodes are parallel to each other, the first electromagnetic coils further includes two first connecting electrodes connecting to the two first sensing electrodes, the first connecting electrodes being arranged along the second direction, the second electromagnetic coils includes two second sensing electrodes arranged along the second direction, and the second sensing electrodes are parallel to each other, the second electromagnetic coils further includes two second connecting electrodes arranged along the first direction, and the two second connecting electrodes connecting to the two second sensing electrodes; and a RGB (Red, Green, and Blue) color film arranged above the insulation layer or the second conductive layer.

Wherein the black matrix includes a plurality of first black (BM) areas extending along the first direction and a plurality of second BM areas extending along the second direction, each of the first sensing electrodes faces toward one first BM area, edges of the first sensing electrode have not exceeded edges of the corresponding first BM area facing toward the respective first sensing electrode, each of the second sensing electrodes faces toward one second BM area, and the edges of the second sensing have not exceeded the edges of the corresponding second BM area facing toward the respective second sensing electrode.

Wherein the electromagnetic touch substrate further includes at least one first filter capacitor respectively connecting to one end of the first electromagnetic coils, at least one second filter capacitor respectively connecting to the one end of the second electromagnetic coils, and connecting leading wires for connecting the first filter capacitor and second filter capacitor to a reference voltage.

Wherein the electromagnetic touch substrate includes a display area and a non-display area, the first filter capacitors, the second filter capacitors, and connecting leading wires are arranged within the non-display area.

Wherein the first connecting electrode and the second connecting electrode are arranged within the non-display area.

Wherein the insulation layer is an organic insulation layer.

In another aspect, an electromagnetic touch substrate includes: a substrate, a first conductive layer, an insulation layer, and a second conductive layer, the first conductive layer includes a plurality of first electromagnetic coils extending along a first direction, the first electromagnetic coils form a loop, the second conductive layer includes a plurality of second electromagnetic coils extending along a second direction, the second electromagnetic coils form a loop, the second direction being vertical to the first direction, the first electromagnetic coils, the insulation layer, and the second electromagnetic coils are arranged on the same side on the substrate in turn, and the insulation layer being configured for separating the first electromagnetic coils and the second electromagnetic coils.

Wherein the electromagnetic touch substrate further includes at least one black matrix arranged on the substrate, the first electromagnetic coils and the second electromagnetic coils are arranged above the black matrix.

Wherein the first electromagnetic coils includes two first sensing electrodes arranged along the first direction, the first sensing electrodes are parallel to each other, the first electromagnetic coils further includes two first connecting electrodes connecting to the two first sensing electrodes, the first connecting electrodes being arranged along the second direction, the second electromagnetic coils includes two second sensing electrodes arranged along the second direction, and the second sensing electrodes are parallel to each other, the second electromagnetic coils further includes two second connecting electrodes arranged along the first direction, and the two second connecting electrodes connect to the two second sensing electrodes.

Wherein the black matrix includes a plurality of first black (BM) areas extending along the first direction and a plurality of second BM areas extending along the second direction, each of the first sensing electrodes faces toward one first BM area, edges of the first sensing electrode have not exceeded edges of the corresponding first BM area facing toward the respective first sensing electrode, each of the second sensing electrodes faces toward one second BM area, and the edges of the second sensing have not exceeded the edges of the corresponding second BM area facing toward the respective second sensing electrode.

Wherein the electromagnetic touch substrate further includes at least one first filter capacitor respectively connecting to one end of the first electromagnetic coils, at least one second filter capacitor respectively connecting to the one end of the second electromagnetic coils, and connecting leading wires for connecting the first filter capacitor and second filter capacitor to a reference voltage.

Wherein the electromagnetic touch substrate includes a display area and a non-display area, the first filter capacitors, the second filter capacitors, and connecting leading wires are arranged within the non-display area.

Wherein the first connecting electrode and the second connecting electrode are arranged within the non-display area.

Wherein the electromagnetic touch substrate further includes a RGB (Red, Green, and Blue) color film arranged above the insulation layer or the second conductive layer.

Wherein the insulation layer is an organic insulation layer.

In another aspect, a display device comprising an electromagnetic touch substrate, the electromagnetic touch substrate including: a substrate, a first conductive layer, an insulation layer, and a second conductive layer, the first conductive layer includes a plurality of first electromagnetic coils extending along a first direction, the first electromagnetic coils form a loop, the second conductive layer includes a plurality of second electromagnetic coils extending along a second direction, the second electromagnetic coils form a loop, the second direction being vertical to the first direction, the first electromagnetic coils, the insulation layer, and the second electromagnetic coils are arranged on the same side on the substrate in turn, and the insulation layer being configured for separating the first electromagnetic coils and the second electromagnetic coils.

Wherein the electromagnetic touch substrate further includes at least one black matrix arranged on the substrate, the first electromagnetic coils and the second electromagnetic coils are arranged above the black matrix; and the first electromagnetic coils includes two first sensing electrodes arranged along the first direction, the first sensing electrodes are parallel to each other, the first electromagnetic coils further includes two first connecting electrodes connecting to the two first sensing electrodes, the first connecting electrodes being arranged along the second direction, the second electromagnetic coils includes two second sensing electrodes arranged along the second direction, and the second sensing electrodes are parallel to each other, the second electromagnetic coils further includes two second connecting electrodes arranged along the first direction, and the two second connecting electrodes connect to the two second sensing electrodes.

Wherein the black matrix includes a plurality of first black (BM) areas extending along the first direction and a plurality of second BM areas extending along the second direction, each of the first sensing electrodes faces toward one first BM area, edges of the first sensing electrode have not exceeded edges of the corresponding first BM area facing toward the respective first sensing electrode, each of the second sensing electrodes faces toward one second BM area, the edges of the second sensing have not exceeded the edges of the corresponding second BM area facing toward the respective second sensing electrode.

Wherein the electromagnetic touch substrate further includes at least one first filter capacitor respectively connecting to one end of the first electromagnetic coils, at least one second filter capacitor respectively connecting to the one end of the second electromagnetic coils, and connecting leading wires for connecting the first filter capacitor and second filter capacitor to a reference voltage; the electromagnetic touch substrate includes a display area and a non-display area, the first filter capacitors, the second filter capacitors, and connecting leading wires are arranged within the non-display area; and the first connecting electrode and the second connecting electrode are arranged within the non-display area.

Wherein the electromagnetic touch substrate further includes a RGB (Red, Green, and Blue) color film arranged above the insulation layer or the second conductive layer.

In view of the above, the electromagnetic touch substrate includes a first conductive layer and a second conductive layer arranged on the same side. The first conductive layer includes a plurality of first electromagnetic coils extending along a first direction, and the first electromagnetic coils form a loop. The second conductive layer includes a plurality of second electromagnetic coils extending along a second direction, and the second electromagnetic coils form a loop. The second direction is vertical to the first direction. In this way, the display panel is embedded with the touch panel so as to provide a thinner electromagnetic touch substrate.

### BRIEF DESCRIPTION OF THE DRAWINGS

FIG. 1 is a schematic view of the inductor of the electromagnetic touch substrate in accordance with one embodiment.

FIG. 2 is a cross sectional view of the inductor of FIG. 1 along the dashed line indicated by “C-C.”

FIG. 3 is an electromagnetic stylus for the electromagnetic touch substrate in accordance with one embodiment.

### DETAILED DESCRIPTION OF THE EMBODIMENTS

Embodiments of the invention will now be described more fully hereinafter with reference to the accompanying drawings, in which embodiments of the invention are shown.

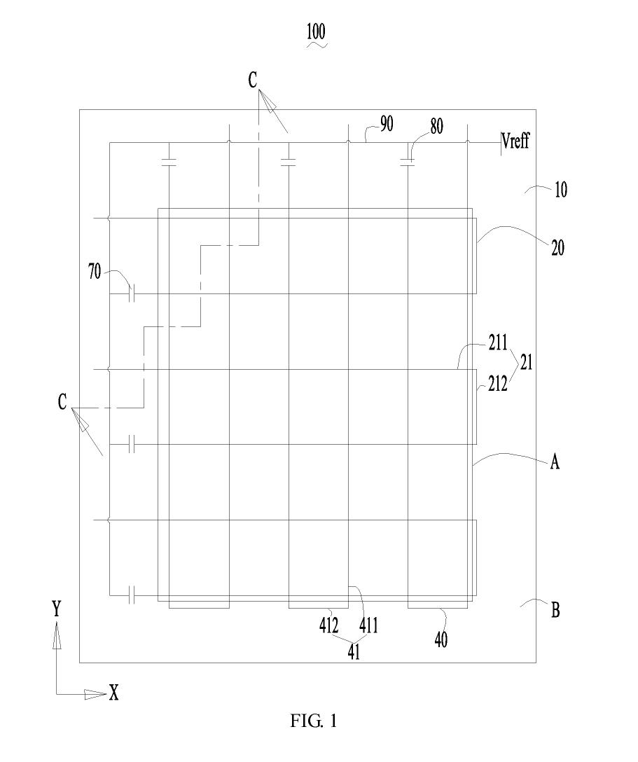

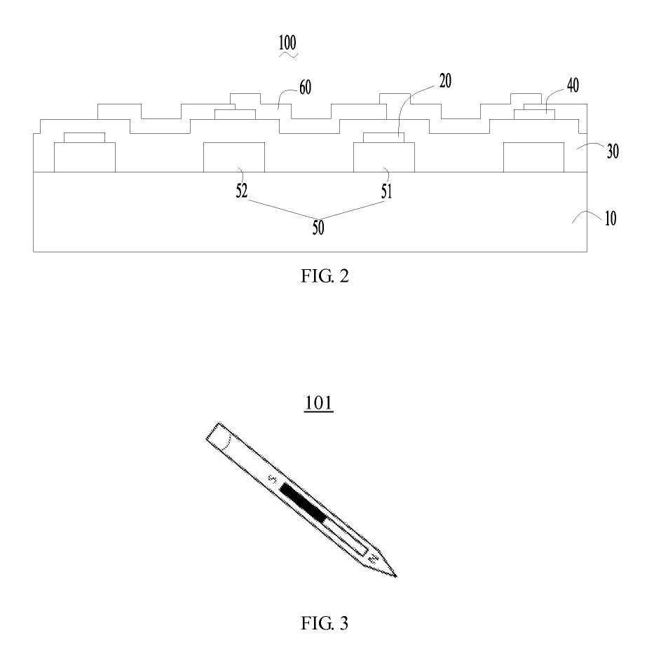

Referring to FIGS. 1 and 2, the electromagnetic touch substrate 100 includes a substrate 10, a first conductive layer 20, an insulation layer 30, and a second conductive layer 40. The first conductive layer 20 includes a plurality of first electromagnetic coils 21 extending along a first direction (X), and the first electromagnetic coils 21 form a loop. The second conductive layer 40 includes a plurality of second electromagnetic coils 41 extending along a second direction (Y), and the second electromagnetic coils 41 form a loop. The second direction (Y) is vertical to the first direction (X). The first electromagnetic coils 21, the insulation layer 30, and the second electromagnetic coils 41 are arranged on the same side on the substrate 10 in turn. In addition, the insulation layer 30 separates the first electromagnetic coils 21 and the second electromagnetic coils 41.

The first electromagnetic coils 21 includes two first sensing electrodes 211 arranged along the first direction (X). The first sensing electrodes 211 are parallel to each other. The first electromagnetic coils 21 further includes two first connecting electrodes 212 connecting to the first sensing electrodes 211. The first connecting electrodes 212 are arranged along the second direction (Y). The second electromagnetic coils 41 includes two second sensing electrodes 411 arranged along the second direction (Y), and the second sensing electrodes 411 are parallel to each other. In addition, the second electromagnetic coils 41 further includes two second connecting electrodes 412 arranged along the first direction (X), and the two second connecting electrodes 412 connect to the two second sensing electrodes 411.

The substrate 10 may be transparent glass substrate or flexible resin substrates. The substrate 10 is for a display area (A) and a non-display area (B) surrounding the display area (A). The first sensing electrodes 211 and the first connecting electrodes 212 are arranged in the display area (A). The first connecting electrodes 212 and the second connecting electrodes 412 area arranged in the non-display area (B).

In the embodiment, the electromagnetic touch substrate 100 may be color film substrates of display devices such as in-plane Switching (IPS), Fringe Field Switching (FFS), Twisted Nematic (TN). The electromagnetic touch substrate 100 further includes a black matrix 50 arranged on the substrate 10 for avoiding the backlight leakage. In this way, the display contrastness is enhanced and the colors are prevented from being mixed, which enhances the purity of the colors. In one embodiment, as the black matrix usually is made by resin materials having black pigment, which is not conductive, the first electromagnetic coils 21 and the 22 are arranged right above the black matrix 50. In other embodiments, the black matrix 50 may be made by conductive materials capable of masking lights, such as Titanium sub-oxides or chromium metal, for transmitting sensing signals. In this way, the first sensing electrodes 211 of the first conductive layer 20 may be made by above-mentioned conductive materials to form the stripe-like black matrix 50.

The black matrix 50 includes a plurality first black matrix (BM) areas 51 extending along the first direction (X) and a plurality of second BM areas 52 extending along the second direction (Y). When each of the first sensing electrodes 211 faces toward one first BM area 51, i.e., each of the first sensing electrodes 211 is arranged above the first BM area, and edges of the first sensing electrodes 211 have not exceeded edges of the corresponding first BM area 51 facing toward the respective first sensing electrode. Each of the second sensing electrodes 411 faces toward one second BM area 52, i.e., each of the second sensing electrodes 411 is arranged above the second BM area. The edges of the second sensing electrodes 411 have not exceeded the edges of the corresponding second BM area 52 facing toward the respective second sensing electrode. As such, the induction coils will not affect the aperture rate of the display device having the touch substrate.

In the embodiment, the first sensing electrodes 211 is configured to be corresponding to a portion or all of the first BM area 51, and a width of the first sensing electrodes 211 is not larger than the width of the first BM area 51. In other words, when viewing from the other side of the substrate 10, the edges of the first BM area 51 may not be revealed as being hide by the first sensing electrodes 211. As such, the lights are prevented from reflected back when users observe the first sensing electrodes 211. In addition, the second sensing electrodes 411 is configured to be corresponding to a portion or all of the second BM area 52, and a width of the second sensing electrodes 411 is not larger than the width of the second BM area 51.

In other embodiments, two or more sensing electrodes are arranged above a portion or all of the BM area. In addition, the width defining by the external edges of the two or more sensing electrodes corresponding to each of the BM area is smaller than the width of the BM area. In the embodiment, two first sensing electrodes face toward the first BM area. The width defining by the external edges of the two first sensing electrode facing toward the first BM area is smaller than the width of the first BM area. In addition, two second sensing electrodes face toward the second BM area. The width defining by the external edges of the two second sensing electrode facing toward the second BM area is smaller than the width of the second BM area.

Preferably, the first sensing electrode is arranged above a portion or all of the first BM area, and the second sensing electrode is arranged above a portion or all of the second BM area. In another example, two first sensing electrode are arranged above the first BM area, and two second sensing electrode are arranged above the second BM area. That is, two first sensing electrodes are arranged above a portion or all of the first BM area, and two second sensing electrodes are arranged above a portion or all of the second BM area.

In the example wherein two sensing electrodes are arranged corresponding to the BM area, the two first sensing electrodes arranged above the first BM area are the first sensing electrodes respectively adjacent to the first electromagnetic coil. The two second sensing electrodes arranged above the second BM area are the second sensing electrodes respectively adjacent to the second electromagnetic coil. In the embodiment, the two first sensing electrode arranged at two lateral sides of the first electromagnetic coil respectively face toward the first BM area. That is, the two first BM areas are respectively arranged with one first sensing electrode, and other first BM areas are respectively arranged with two first sensing electrodes. The two second sensing electrode arranged at two lateral sides of the second electromagnetic coil respectively face toward the second BM area. That is, the two second BM areas are respectively arranged with one second sensing electrode, and other second BM areas are respectively arranged with two second sensing electrodes.

The insulation layer 30 is arranged to cover the first conductive layer 20 of the display area (A). In another example, the insulation layer 30 is arranged to cover the display area (A). The first electromagnetic coils 21 and the second electromagnetic coils 41 above the black matrix 50 may be manufactured by Vapor-Phase Deposition. Preferably, the first electromagnetic coils 21 and the second electromagnetic coils 41 may be aluminum, chromium, molybdenum, copper or titanium. The insulation layer 30 may be an organic insulation layer made by organic polymer. The organic insulation layer may be manufactured by spray coating. Comparing to the inorganic insulation layer, the organic insulation layer is characterized by attributes such as simple manufacturing process, short manufacturing time, high efficiency, and low cost.

The electromagnetic touch substrate 100 further includes at least one first filter capacitor 70 respectively connecting to one end of the first electromagnetic coils 21, at least one second filter capacitor 80 respectively connecting to the one end of the second electromagnetic coils 41, and connecting leading wires 90 for connecting the first filter capacitor 70 and second filter capacitor 80 to a reference voltage (Vreff). The first filter capacitor 70 and the second filter capacitor 80 are configured to prevent the electromagnetic touch substrate 100 from being interfered by the electromagnetic waves. The first filter capacitors 70, the second filter capacitors 80, and the connecting leading wires 90 are arranged within the non-display area (B) of the substrate 10 substrate 10. The first connecting electrodes 212, the second connecting electrodes 412, the first filter capacitors 70, the second filter capacitors 80, and the connecting leading wire 90 are arranged within the non-display area (B) of the substrate 10 so as to enhance the uniformity of the images shown in the display area (A).

Both of the other end of the first electromagnetic coils 21 and the other end of the second electromagnetic coils 41 connect to at least one driving chip (not shown) for receiving the sensing signals.

In the embodiment, the electromagnetic touch substrate 100 adopting the color film substrate further includes a RGB (Red, Green, and Blue) color film 60. The RGB color film 60 is arranged above the insulation layer 30 or the second conductive layer 40.

In one embodiment, the electromagnetic touch substrate 100 is manufactured in the following process. The substrate 10 is provided. The substrate 10 includes the display area (A) located in a central location and a non-display area (B) located in a rim of the display area (A). The display area (A) of the substrate 10 includes a black matrix 50 having a plurality of first BM areas 51 extending along the first direction (X) and a plurality of second BM areas 52 extending along the second direction (Y). A first conductive layer 20 is formed. The first conductive layer 20 includes a plurality of first electromagnetic coils 21 extending along a first direction (X), and the first electromagnetic coils 21 form a loop. The first electromagnetic coils 21 includes two first sensing electrodes 211 arranged along the first direction (X). The first sensing electrodes 211 are parallel to each other. The first electromagnetic coils 21 further includes two first connecting electrodes 212 connecting to the first sensing electrodes 211. Each of the first sensing electrodes 211 is arranged above the first BM area 50, and edges of the first sensing electrodes 211 has not exceeded edges of the corresponding first BM area 51. The first connecting electrodes 212 is formed within the non-display area (B) of the substrate 10. The insulation layer 30 is formed. The insulation layer 30 covers the first sensing electrodes 211 above the black matrix 50. The second conductive layer 40 is formed. The second conductive layer 40 includes a plurality of second electromagnetic coils 41 extending along a second direction (Y), and the second electromagnetic coils 41 form a loop. The second electromagnetic coils 41 includes two second sensing electrodes 411 arranged along the second direction (Y), and the second sensing electrodes 411 are parallel to each other. In addition, the second electromagnetic coils 41 further includes two second connecting electrodes 412 arranged along the first direction (X), and the second connecting electrodes 412 connect to the second sensing electrodes 411. Each of the second sensing electrodes 411 is arranged above the second BM area 52. The edges of the second sensing electrodes 411 has not exceeded the edges of the corresponding second BM area 52. The second connecting electrodes 412 is formed within the non-display area (B) of the substrate 10. The non-display area (B) of the substrate 10 further includes at least one first filter capacitor 70 respectively corresponding to each of the first electromagnetic coils 21, at least one the second filter capacitor 80 respectively corresponding to each of the second electromagnetic coils 41, and the connecting leading wires 90. One end of the first electromagnetic coils 21 connects to the first filter capacitor 70. One end of the second electromagnetic coils 41 connects to the second filter capacitor 80. The connecting leading wires 90 connect the first filter capacitor 70 and the second filter capacitor 80 to the reference voltage (Vreff). The other end of the first electromagnetic coils 21 and the other end of the second electromagnetic coils 41 connect to one driving chip. The RGB color film is formed above the insulation layer 30 or the second conductive layer 40.

It is to be noted that the above process of the electromagnetic touch substrate 100 is only one example, and the present disclosure is not limited thereto.

With respect to the above manufacturing process, the black matrix 50 and the RGB color film 60 may be made by conventional solution. The first conductive layer 20 and the second conductive layer 40 may be made by the solution for manufacturing the electrodes of array substrates. The insulation layer 30 may be made by organic polymer via spray coating process.

In view of the above, the electromagnetic touch substrate 100 includes a first conductive layer 20 and a second conductive layer 40 arranged on the same side. The first conductive layer 20 includes a plurality of first electromagnetic coils 21 extending along a first direction (X), and the first electromagnetic coils 21 form a loop. The second conductive layer 40 includes a plurality of second electromagnetic coils 41 extending along a second direction (Y), and the second electromagnetic coils 41 form a loop. The second direction (X) is vertical to the first direction (Y). In this way, the display panel is embedded with the touch panel so as to provide a thinner electromagnetic touch substrate. In addition, the first electromagnetic coils 21 and the second electromagnetic coils 41 are arranged above the black matrixes to operate as positioning lines for the electromagnetic operations. The inductive single point touch is achieved without affecting the aperture rate and the thickness of the display panel.

According to the present disclosure, a device including the above-mentioned electromagnetic touch substrate 100 and an electromagnetic stylus 101 for providing a magnetic field. When the electromagnetic stylus 101 moves above the electromagnetic touch substrate 100, the first electromagnetic coils 21 and the second electromagnetic coils 41 may generate a sensing current due to a density of flux change. As such, the driving chip may sense the sensing current so as to determine the coordinate of the touch points.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electromagnetic touch substrate, comprising:
a substrate, a first conductive layer, an insulation layer, and a second conductive layer, the first conductive layer comprises a plurality of first electromagnetic coils extending along a first direction, the first electromagnetic coils form a loop, the second conductive layer comprises a plurality of second electromagnetic coils extending along a second direction, the second electromagnetic coils form a loop, the second direction being vertical to the first direction, the first electromagnetic coils, the insulation layer, and the second electromagnetic coils are arranged on the same side on the substrate in sequence, and the insulation layer being configured for separating the first electromagnetic coils and the second electromagnetic coils;
at least one black matrix arranged on the substrate, the first electromagnetic coils and the second electromagnetic coils are arranged above the black matrix;
the first electromagnetic coils comprises two first sensing electrodes arranged along the first direction, the first sensing electrodes are parallel to each other, the first electromagnetic coils further comprises two first connecting electrodes connecting to the two first sensing electrodes, the first connecting electrodes being arranged along the second direction, the second electromagnetic coils comprises two second sensing electrodes arranged along the second direction, and the second sensing electrodes are parallel to each other, the second electromagnetic coils further comprises two second connecting electrodes arranged along the first direction, and the two second connecting electrodes connecting to the two second sensing electrodes; and
a RGB (Red, Green, and Blue) color film arranged above the insulation layer or the second conductive layer.

2. The electromagnetic touch substrate as claimed in claim 1, wherein the black matrix comprises a plurality of first black (BM) areas extending along the first direction and a plurality of second BM areas extending along the second direction, each of the first sensing electrodes faces toward one first BM area, edges of the first sensing electrode have not exceeded edges of the corresponding first BM area facing toward the respective first sensing electrode, each of the second sensing electrodes faces toward one second BM area, and the edges of the second sensing have not exceeded the edges of the corresponding second BM area facing toward the respective second sensing electrode.

3. The electromagnetic touch substrate as claimed in claim 1, wherein the electromagnetic touch substrate further comprises at least one first filter capacitor respectively connecting to one end of the first electromagnetic coils, at least one second filter capacitor respectively connecting to the one end of the second electromagnetic coils, and connecting leading wires for connecting the first filter capacitor and second filter capacitor to a reference voltage.

4. The electromagnetic touch substrate as claimed in claim 3, wherein the electromagnetic touch substrate comprises a display area and a non-display area, the first filter capacitors, the second filter capacitors, and connecting leading wires are arranged within the non-display area.

5. The electromagnetic touch substrate as claimed in claim 4, wherein the first connecting electrode and the second connecting electrode are arranged within the non-display area.

6. The electromagnetic touch substrate as claimed in claim 1, wherein the insulation layer is an organic insulation layer.

7. An electromagnetic touch substrate, comprising:
a substrate, a first conductive layer, an insulation layer, and a second conductive layer, the first conductive layer comprises a plurality of first electromagnetic coils extending along a first direction, the first electromagnetic coils form a loop, the second conductive layer comprises a plurality of second electromagnetic coils extending along a second direction, the second electromagnetic coils form a loop, the second direction being vertical to the first direction, the first electromagnetic coils, the insulation layer, and the second electromagnetic coils are arranged on the same side on the substrate in turn, and the insulation layer being configured for separating the first electromagnetic coils and the second electromagnetic coils.

8. The electromagnetic touch substrate as claimed in claim 7, wherein the electromagnetic touch substrate further comprises at least one black matrix arranged on the substrate, the first electromagnetic coils and the second electromagnetic coils are arranged above the black matrix.

9. The electromagnetic touch substrate as claimed in claim 8, wherein the first electromagnetic coils comprises two first sensing electrodes arranged along the first direction, the first sensing electrodes are parallel to each other, the first electromagnetic coils further comprises two first connecting electrodes connecting to the two first sensing electrodes, the first connecting electrodes being arranged along the second direction, the second electromagnetic coils comprises two second sensing electrodes arranged along the second direction, and the second sensing electrodes are parallel to each other, the second electromagnetic coils further comprises two second connecting electrodes arranged along the first direction, and the two second connecting electrodes connect to the two second sensing electrodes.

10. The electromagnetic touch substrate as claimed in claim 9, wherein the black matrix comprises a plurality of first black (BM) areas extending along the first direction and a plurality of second BM areas extending along the second direction, each of the first sensing electrodes faces toward one first BM area, edges of the first sensing electrode have not exceeded edges of the corresponding first BM area facing toward the respective first sensing electrode, each of the second sensing electrodes faces toward one second BM area, and the edges of the second sensing have not exceeded the edges of the corresponding second BM area facing toward the respective second sensing electrode.

11. The electromagnetic touch substrate as claimed in claim 9, wherein the electromagnetic touch substrate further comprises at least one first filter capacitor respectively connecting to one end of the first electromagnetic coils, at least one second filter capacitor respectively connecting to the one end of the second electromagnetic coils, and connecting leading wires for connecting the first filter capacitor and second filter capacitor to a reference voltage.

12. The electromagnetic touch substrate as claimed in claim 11, wherein the electromagnetic touch substrate comprises a display area and a non-display area, the first filter capacitors, the second filter capacitors, and connecting leading wires are arranged within the non-display area.

13. The electromagnetic touch substrate as claimed in claim 12, wherein the first connecting electrode and the second connecting electrode are arranged within the non-display area.

14. The electromagnetic touch substrate as claimed in claim 8, wherein the electromagnetic touch substrate further comprises a RGB (Red, Green, and Blue) color film arranged above the insulation layer or the second conductive layer.

15. The electromagnetic touch substrate as claimed in claim 7, wherein the insulation layer is an organic insulation layer.

16. A display device comprising an electromagnetic touch substrate, the electromagnetic touch substrate comprising:
a substrate, a first conductive layer, an insulation layer, and a second conductive layer, the first conductive layer comprises a plurality of first electromagnetic coils extending along a first direction, the first electromagnetic coils form a loop, the second conductive layer comprises a plurality of second electromagnetic coils extending along a second direction, the second electromagnetic coils form a loop, the second direction being vertical to the first direction, the first electromagnetic coils, the insulation layer, and the second electromagnetic coils are arranged on the same side on the substrate in turn, and the insulation layer being configured for separating the first electromagnetic coils and the second electromagnetic coils.

17. The display device as claimed in claim 16, wherein the electromagnetic touch substrate further comprises at least one black matrix arranged on the substrate, the first electromagnetic coils and the second electromagnetic coils are arranged above the black matrix; and
the first electromagnetic coils comprises two first sensing electrodes arranged along the first direction, the first sensing electrodes are parallel to each other, the first electromagnetic coils further comprises two first connecting electrodes connecting to the two first sensing electrodes, the first connecting electrodes being arranged along the second direction, the second electromagnetic coils comprises two second sensing electrodes arranged along the second direction, and the second sensing electrodes are parallel to each other, the second electromagnetic coils further comprises two second connecting electrodes arranged along the first direction, and the two second connecting electrodes connect to the two second sensing electrodes.

18. The display device as claimed in claim 17, wherein the black matrix comprises a plurality of first black (BM) areas extending along the first direction and a plurality of second BM areas extending along the second direction, each of the first sensing electrodes faces toward one first BM area, edges of the first sensing electrode have not exceeded edges of the corresponding first BM area facing toward the respective first sensing electrode, each of the second sensing electrodes faces toward one second BM area, the edges of the second sensing have not exceeded the edges of the corresponding second BM area facing toward the respective second sensing electrode.

19. The display device as claimed in claim 17, wherein the electromagnetic touch substrate further comprises at least one first filter capacitor respectively connecting to one end of the first electromagnetic coils, at least one second filter capacitor respectively connecting to the one end of the second electromagnetic coils, and connecting leading wires for connecting the first filter capacitor and second filter capacitor to a reference voltage;
the electromagnetic touch substrate comprises a display area and a non-display area, the first filter capacitors, the second filter capacitors, and connecting leading wires are arranged within the non-display area; and
the first connecting electrode and the second connecting electrode are arranged within the non-display area.

20. The display device as claimed in claim 17, wherein the electromagnetic touch substrate further comprises a RGB (Red, Green, and Blue) color film arranged above the insulation layer or the second conductive layer.
